(19) United States
(12) Patent Application Publication
(10) Pub. No.: US 2005/0068264 A1
(43) Pub. Date: Mar. 31, 2005

(54) Display device

(75) Inventor: Kazuo Yahagi, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/947,127

(22) Filed: Sep. 23, 2004

(30) Foreign Application Priority Data
Sep. 25, 2003 (JP) 2003-333080
Jul. 28, 2004 (JP) 2004-220222

(51) Int. Cl. G09G 3/28

(52) U.S. Cl. 345/60

(57) ABSTRACT

It is an object to provide a display device capable of simplifying the interconnection between a display panel and a driver for driving the display panel. A plurality of connection terminals for connection to display electrodes arranged at odd-number-th positions of the display panel is provided at one end in the row direction on a front substrate of the display panel. A plurality of connection terminals for connection to display electrodes arranged at even-number-th positions of the display panel is provided at the other end in a row direction on the front substrate. On the front substrate is mounted a driver for applying a drive pulse to the display electrode arranged at odd-number-th positions through the respective connection terminals provided at one end in a row direction on the front substrate. On the front substrate is mounted a driver for applying a drive pulse to the display electrode arranged at even-number-th through the respective connection terminals provided at the other end in a row direction on the front substrate.

### BACKGROUND OF THE INVENTION

1. Field of the Invention

The present invention relates to a display device mounted with a display panel.

2. Description of the Related Art

There are commercially produced plasma displays mounted with plasma display panel (hereinafter, referred to as PDP) as a color display panel which is thin with large screen.

The PDP is oppositely arranged with a front glass substrate as a display surface and a back substrate, through a discharge space filled with a discharge gas. The front glass substrate is formed with a plurality of strip-formed row electrodes extending in a row direction of the display surface, on an inner surface (surface opposed to the back substrate). The back substrate is formed with a plurality of strip-formed column electrodes extending in a column direction of the display surface. The adjacent row electrodes in a pair (hereinafter, referred to as row electrode pair) serve as one display line. Discharge cells, as pixels, are formed at intersections of the row electrode pairs and the column electrodes.

Furthermore, the PDP is provided with a row electrode driver for applying various pulses (referred later) to the row electrodes and an address driver for applying to the column electrodes a pixel data pulse corresponding to an input video signal.

The row electrode driver first applies a reset pulse simultaneously to all the row electrode pairs, to cause reset-discharge on all the discharge cells. By such reset discharge, on-wall charge is formed within all the discharge cells. The address driver applies a pixel data pulse in an amount of one display line per time to the column electrodes. In this duration, the row electrode driver applies a scan pulse sequentially to one row electrodes of the row electrode pairs, in order to put the discharge cells belonging to the display lines into subjects of address discharge in an amount of one display liner per time. On this occasion, address discharge is caused within the discharge cell where a high-voltage pixel data pulse and a scan pulse are applied at the same time, thereby erasing the on-wall charge remaining within the discharge cell. Next, the row electrode driver applies sustain pulses alternately and repeatedly to the row electrodes of all the row electrode pairs. On this occasion, sustain discharge takes place only in the discharge cells having the remaining on-wall charge each time the sustain pulse is applied. The sustain discharge provides luminescence to cause an image corresponding to an input image signal to appear on a display surface of the front glass substrate correspondingly to the input video signal.

However, the above driving causes a luminescent discharge, such as reset discharge and address discharge, that is not to involve in displaying an image, thus raising a problem of lowered contrast in a display image.

For this reason, a proposal has been made on a PDP achieving to improve the contrast of display image by suppressing the luminescence as caused by reset and address discharge (e.g. JP-A-2003-86108).

FIG. 1 is a figure of part of such a PDP as viewed from a display surface side. FIG. 2 is a figure showing a section along V1-V1 of the display panel shown in FIG. 1.

In the PDP shown in FIG. 1, each discharge cell is constructed by a discharge cell C1 for causing sustain discharge only, and a reset-and-address discharge cell C2 for causing reset and address discharge with luminescence not involved in displaying an image. In the reset-and-address discharge cell C2, a light-absorbing layer 18 is formed in black or dark color so that the luminescence resulting from the discharge caused within the reset-and-address discharge cell C2 is prevented from radiating toward the display surface.

Consequently, according the PDP structured as shown in FIGS. 1 and 2, there is a significant reduction in amount of the light caused by reset and address discharge and leaking toward the display surface. This improves the contrast of a display image.

In the meanwhile, in the PDP, the row electrode X belonging to the discharge cell C1 within a discharge cell is shared as a row electrode X belonging to the reset-and-address discharge cell C1 within the discharge cell adjacent,above to that discharge cell. Accordingly, there is a need to drive, in different timing, the discharge cell belonging to the odd display line and the discharge cell belonging to the even display line.

For this reason, four row electrode drivers as shown in FIG. 3 are employed in addition to the address driver for driving the column electrode in order for driving the PDP.

In FIG. 3, an odd-X electrode driver XDo applies a reset pulse or sustain pulse to the row electrodes X₁, X₃, X₅, . . . , Xₙ₋₁ belonging to the odd display lines of the PDP structured as shown in FIGS. 1 and 2. An even-X electrode driver XDe applies a reset pulse or sustain pulse to the row electrodes X₀, X₂, X₄, . . . , Xₙ belonging to the even display lines of the PDP. An odd-Y electrode driver YDo applies a reset pulse, scan pulse or sustain pulse to the row electrodes Y₁, Y₃, Y₅, . . . , Yₙ₋₁ belonging to the odd display lines of the PDP. An even-Y electrode driver YDe applies a reset pulse, scan pulse or sustain pulse to the row electrodes Y₂, Y₄, . . . , Yₙ belonging to the even display lines of the PDP.

Accordingly, there arises a problem of complicated interconnections, in case the odd-X electrode driver XDo, the even-X electrode driver XDe and the odd-Y electrode driver YDo are arranged close to the PDP to thereby connect between the drivers and the row electrodes as shown in FIG. 3.

Meanwhile, because of application of one of a reset pulse and a sustain pulse, which have a high-voltage, to between the extension electrode of the row electrode Y₁, Y₃, . . . , Yₙ₋₁ belonging to the odd display line and the extension electrode of the row electrode Y₂, Y₄, . . . , Yₙ belonging to the even display line, there is a fear to cause a problem of migration, poor breakdown voltage or the like at between the extension electrodes. Furthermore, because of the existence of a floating capacitance on the line connected from the extension electrode terminal and to the drivers, there encounters a problem of an ineffective charge/discharge to/from the floating capacitance thus resulting in increase of ineffective power.

The present invention has been made in order to solve at least part of the problems, and it is an object thereof to provide a display device the drive conditions of which can be improved.

### SUMMARY OF THE INVENTION

A display device of one aspect of the present invention which has a display panel having a front substrate and a back substrate that are oppositely arranged sandwiching a discharge space, a plurality of electrodes X and electrodes Y extending in a row direction and arranged on the front substrate, and a plurality of address electrodes arranged crossing the electrodes Y and the electrodes X respectively, to form unit luminescent regions at intersections of pairs of the electrodes Y and X and the address electrodes, comprises: a plurality of odd-Y electrode connection terminals formed at one end of the front substrate in the row direction, the plurality of odd-Y electrode connection terminals being connected to respective electrodes Y arranged at odd-number-th positions; an odd-X electrode connection terminal formed at the one end of the front substrate in the row direction, the odd-X electrode connection terminal being connected to the electrodes X arranged at odd-number-th positions; a plurality of even-Y electrode connection terminals formed at other end of the front substrate in the row direction, the plurality of even-Y electrode connection terminals being connected to respective electrodes Y arranged at even-number-th positions; an even-X electrode connection terminal formed at the other end of the front substrate in the row direction, the even-X electrode connection terminal being connected to the electrodes X arranged at even-number-th positions; an odd-Y electrode driver for applying a scanning pulse sequentially to each of the electrodes Y arranged at odd-number-th positions through the respective odd-Y electrode connection terminals; an even-Y electrode driver for applying a scanning pulse sequentially to each of the electrodes Y arranged at even-number-th positions through the respective even-Y electrode connection terminals; an odd-X electrode driver for applying a sustain pulse repeatedly to the electrodes X arranged at odd-number-th positions through the odd-X electrode connection terminal; and an even-X electrode driver for applying a sustain pulse repeatedly to the electrodes X arranged at even-number-th positions through the even-X electrode connection terminal.

Meanwhile, a display device of another aspect of the present invention which has a display panel having front and a back substrates oppositely arranged sandwiching a discharge space, a plurality of electrodes X and electrodes Y arranged extending in a row direction on the front substrate, and a plurality of address electrodes arranged crossing the electrodes Y and the electrodes X, to form unit luminescent regions at intersections of pairs of the electrodes Y and X and the address electrodes, comprises: a plurality of odd-Y electrode connection terminals formed at one end of the front substrate in the row direction, the plurality of odd-Y electrode connection terminals being connected to respective electrodes Y arranged at odd-number-th positions; an even-X electrode connection terminal formed at the one end of the front substrate in the row direction, the even-X electrode connection terminal being connected to the electrodes X arranged at even-number-th positions; a plurality of even-Y electrode connection terminals formed at other end of the front substrate in the row direction, the plurality of even-Y electrode connection terminals being connected to respective electrodes Y arranged at even-number-th positions; an odd-X electrode connection terminal formed at the other end of the front substrate in the row direction, the odd-X electrode connection terminal being connected to the electrodes X arranged at odd-number-th positions; a first reset driver for generating a first reset pulse and applying it to the even-X electrode connection terminal and each of the odd-Y electrode connection terminals; a first sustain driver for generating a first sustain pulse and applying it to the even-X electrode connection terminal and each of the odd-Y electrode connection terminals; a first scanning driver for generating a scanning pulse and applying it sequentially to each of odd-Y electrode connection terminals; a second reset driver for generating a second reset pulse and applying it to the odd-X electrode connection terminal and each of the even-Y electrode connection terminals; a second sustain driver for generating a second sustain pulse and applying it to the odd-X electrode connection terminal and each of the even-Y electrode connection terminals; and a second scanning driver for generating a scanning pulse and applying it sequentially to each of the even-Y electrode connection terminals.

### BRIEF DESCRIPTION OF THE DRAWINGS

FIG. 1 is a plan view of part of a conventional PDP structure as viewed from a display surface side;

FIG. 2 is a view showing a section of the PDP on line V-V shown in FIG. 1;

FIG. 3 is a diagram showing a schematic arrangement of a conventional plasma display device;

FIG. 4 is a diagram showing a schematic arrangement of a plasma display device according to the present invention;

FIG. 5 is a plan view of part of a display electrode-formed portion DE of a PDP 50 shown in FIG. 4, as viewed from a display surface side;

FIG. 6 is a view showing a section on line V1-V1 shown in FIG. 5;

FIG. 7 is a view showing a section on line V2-V2 shown in FIG. 5;

FIG. 8 is a view showing a section on line W1-W1 shown in FIG. 5;

FIG. 9 is a figure showing a pixel data conversion table and a luminescence drive pattern based on the pixel drive data GD obtained by the pixel data conversion table;

FIG. 10 is a figure showing an example of a luminescence drive sequence in the plasma display device shown in FIG. 4;

FIG. 11 is a figure showing various drive pulses to be applied to the PDP 50 according to the luminescence drive sequence shown in FIG. 10 and the timing thereof;

FIG. 12 is a plan view showing another structure of the display electrode-formed region;

FIG. 13 is a view showing a section on line V1-V1 shown in FIG. 12;

FIG. 14 is a view showing a section on line V2-V2 shown in FIG. 12;

FIG. 15 is a view showing a section on line W1-W1 shown in FIG. 12;

FIG. 16 is a view showing a section on line W2-W2 shown in FIG. 12; and

FIG. 17 is a diagram showing another example of a schematic arrangement of a plasma display device according to the invention.

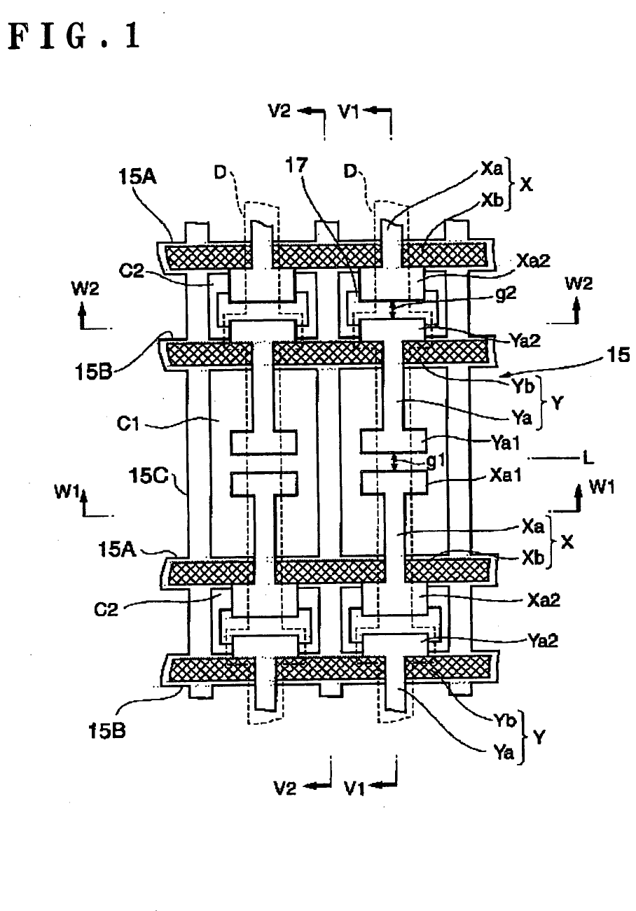

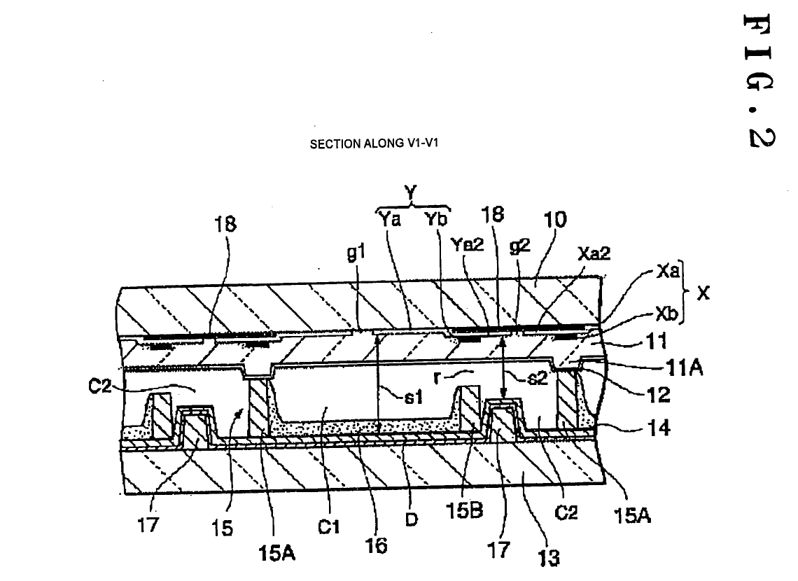

### DETAILED DESCRIPTION OF THE INVENTION

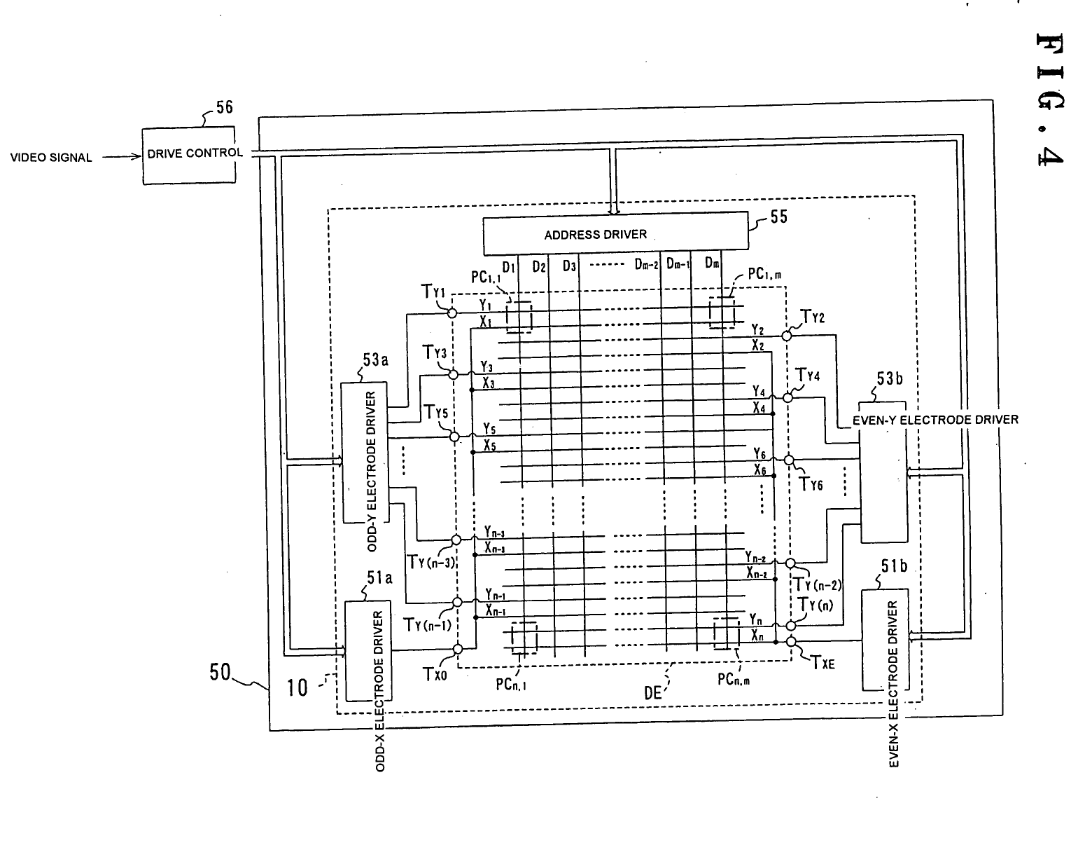

FIG. 4 is a diagram showing an arrangement of a plasma display device as a display device according to the present invention.

As shown in FIG. 4, the plasma display device comprises a PDP 50 as a plasma display panel and a drive control circuit 56 for controlling the driving to the PDP 50 according to an input video signal.

In a display electrode-formed portion DE of the PDP 50, there are formed column electrodes (address electrodes) D₁-Dₘ each formed extending in a column direction (in the vertical direction) of the display screen. Furthermore, in the display electrode-formed portion DE, there are formed row electrodes X₁-Xₙ and Y₁-Yₙ extending in a row direction of the display screen (in the left-right direction) alternately of X-Y and in an numbered order, as shown in FIG. 4. In this case, the pairs of adjacent ones of row electrodes, i.e. row electrode pairs (X₁, Y₁)-(Xₙ, Yₙ), respectively correspond to the first to n-th display lines of the PDP 50. Pixel cells PC, as pixels, are formed respectively at the intersections of the display lines and the column electrodes D₁-Dₘ (in the region of the one-dot chain line in FIG. 4).

The odd numbered row electrodes X₁, X₃, X₅, . . . , Xₙ₋₃ and Xₙ₋₁ are commonly connected to a connection terminal T_{XO} provided at a left end of the display electrode-formed portion DE. The even numbered row electrodes X₂, X₄, X₆, . . . , Xₙ₋₂ and Xₙ are commonly connected to a connection terminal T_{XE} provided at a right end of the display electrode-formed portion DE. The odd numbered row electrodes Y₁, Y₃, Y₅ . . . , Yₙ₋₃ and Yₙ₋₁ are connected separately to the respective connection terminals T_{Y1}, T_{Y3}, T_{Y5}, . . . , T_{Y(n-3)} and T_{Y(n-1)} provided at the left end of the display electrode-formed portion DE. The even numbered row electrodes Y₂, Y₄, . . . , Yₙ₋₂ and Yₙ are connected separately to the respective connection terminals T_{Y2}, T_{Y4}, . . . , T_{Y(n-2)} and T_{Y(n)} provided at the right end of the display electrode-formed portion DE.

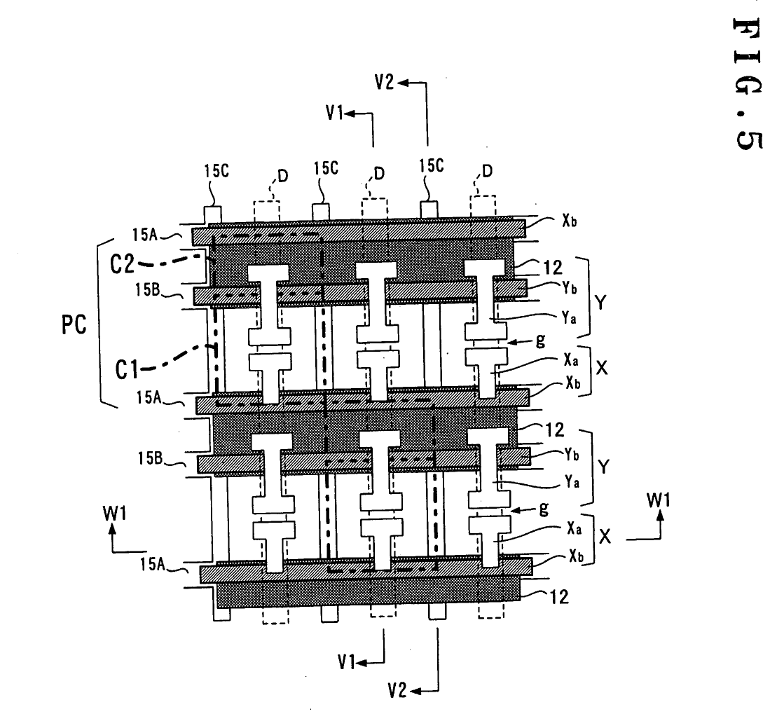

FIGS. 5 to 8 are views showing part of an internal structure of the display electrode-formed portion DE.

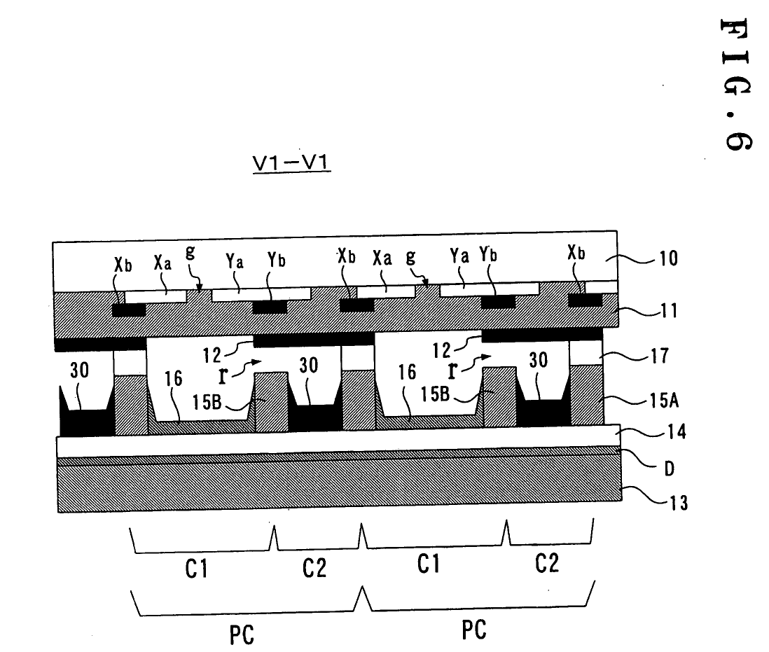

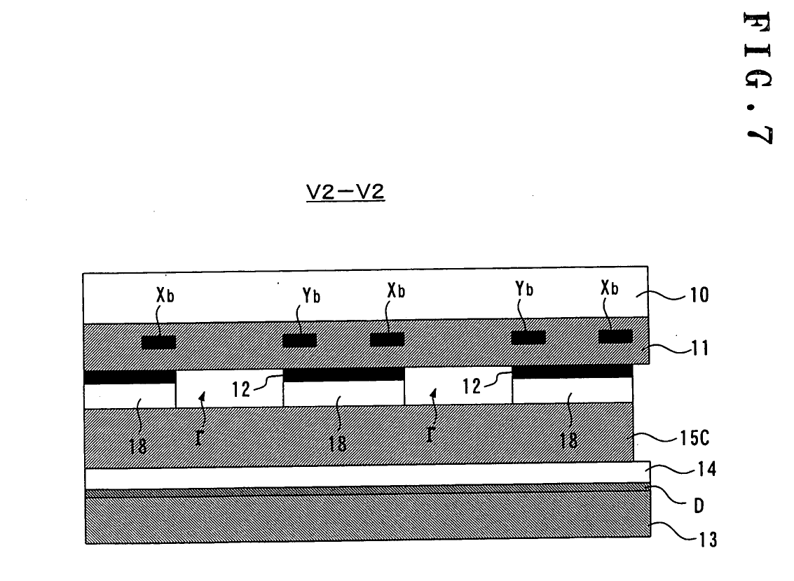

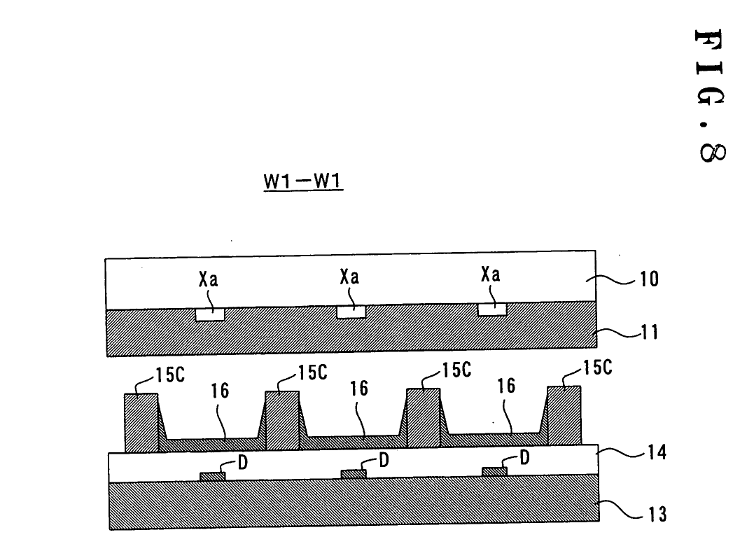

FIG. 5 is a plan view as viewed from the display surface side. FIG. 6 is a sectional view as viewed from line V1-V1 shown in FIG. 5. FIG. 7 is a sectional view as viewed from line V2-V2 shown in FIG. 5. FIG. 8 is a sectional view as viewed from line W2-W2 shown in FIG. 5.

As shown in FIG. 5, the row electrode Y is constituted by a bus electrode Yb (main body portion of the row electrode Y) in a strip extending in the row (left-right) direction of the display screen and a plurality of transparent electrodes Ya connected to the bus electrode Yb. The bus electrode Yb is formed by a black metal film, for example. The transparent electrodes Ya are formed by a transparent conductive film such as of ITO, and arranged on the bus electrode Yb respectively in positions corresponding to the column electrodes D. The transparent electrode Ya extends in a direction orthogonal to the bus electrode Yb, one end and other end of which are each made in a widened form as shown in FIG. 5. Namely, the transparent electrode Ya can be grasped as a projection electrode projecting from the main body portion of the row electrode Y. Meanwhile, the row electrode X is constituted by a bus electrode Xb (main body portion of the row electrode X) in a strip extending in the row (left-right) direction of the display screen and a plurality of transparent electrodes Xa connected to the bus electrode Xb. The bus electrode Xb is formed by a black metal film, for example. The transparent electrodes Xa are formed by a transparent conductive film such as of ITO, and arranged on the bus electrode Xb respectively in positions corresponding to the column electrodes D. The transparent electrode Xa extends in a direction orthogonal to the bus electrode Xb, whose one end is made in a widened form as shown in FIG. 5. Namely, the transparent electrode Xa can be grasped as a projection electrode projecting from the main body of the row electrode X. The widened portions of the transparent electrodes Xa and Ya are arranged oppositely to each other through a predetermined width of discharge gap g, as shown in FIG. 5. Namely, the transparent electrodes Xa and Ya, as projection electrodes projecting from the main bodies of the paired row electrodes X and Y, are oppositely arranged to each other through the discharge gap g.

The row electrodes Y, comprised of the transparent electrodes Ya and bus electrodes Yb and the row electrodes X, comprised of the transparent electrodes Xa and bus electrodes Xb, are formed on an inner surface of a front transparent substrate 10 as a display surface of the PDP 50, as shown in FIG. 6. Furthermore, a dielectric layer 11 is formed on a back surface of the front transparent substrate 10, to cover over those row electrodes X and Y. On the surface of the dielectric layer 11, a bulked-up dielectric layer 12 is formed protruding from the dielectric layer 11 toward the backside, in positions corresponding to the select cell C2 (referred later). The bulked-up dielectric layer 12 is formed by a strip-formed light-absorbing layer containing a black or dark-color pigment, to extend in a row (left-right) direction of the display surface as shown in FIG. 5. The bulked-up dielectric layer 12 and the dielectric layer 11 free of the bulk-up dielectric layer 12 have their surfaces covered with a protection layer (not shown) of MgO (magnesium oxide). On a back substrate 13 placed parallel with the front transparent substrate 10, a plurality of column electrodes D are arranged in parallel one with another through a predetermined gap and extending in a direction orthogonal to the bus electrodes Xb and Yb. On the back substrate 13, a column-electrode protection layer (dielectric layer) 14 in white is formed covering over the column electrodes D. On the column-electrode protection layer 14, a partition 15 is formed comprising a first row partition 15A, a second row partition 15B and a column partition 15C. The first row partition 15A is formed extending in the row (left-right) direction of the display surface, in a position on the column-electrode protection layer 14 opposed to the bus electrode Yb. The second row partition 15B is formed extending in the row (left-right) direction of the display surface, in a position on the column-electrode protection layer 14 opposed to the bus electrode Xb. The column partition 15C is formed extending in a direction orthogonal to the bus electrode Xb (Yb), in a position between the transparent electrodes Xa (Ya) arranged at an equal interval on the bus electrode Xb (Yb).

As shown in FIG. 6, a secondary-electron emitting material layer 30 is formed on the column electrode protection layer 14 in a region opposed to the bulked-up dielectric layer 12 (including side surfaces of the column partition 15C and the first and second row partitions 15A and 15B). The secondary-electron emitting material layer 30 is a layer formed of a high-γ material low in work function (e.g. 4.2 eV or lower) but high in so-called secondary electron emission coefficient. The secondary electron emitting material layer 30 employs a material including, for example, an alkali earth metal oxide such as MgO, CaO, SrO and BaO; an alkali metal oxide such as Cs₂O; a fluoride such as CaF₂ and MgF₂; TiO₂, Y₂O₃; a material enhanced in secondary electron emission coefficient by crystal defect or impurity dope; a diamond-like thin film, a carbon nano-tube, and so on. Meanwhile, a fluorescent layer 16 is formed on the column electrode protection layer 14 in the other region than the region opposed to the bulked-up dielectric layer 12 (including side surfaces of the column partition 15C and the first and second row partitions 15A and 15B), as shown in FIG. 6. The fluorescent layer 16 includes three types of a red fluorescent layer for luminescence in red, a green fluorescent layer for luminescence in green and a blue fluorescent layer for luminescence in blue, which are fixedly assigned to the pixel cells PC. There exists a discharge space filled with a discharge gas and defined between the secondary electron emitting layer 30 and fluorescent layer 16 and the dielectric layer 11. The first and second row partitions 15A, 15B and the column partition 15C are not so high as reaching a surface of the bulked-up dielectric layer 12 or dielectric layer 11, as shown in FIGS. 6 and 8. Thus, a gap r exists between the second row partition 15B and the bulked-up dielectric layer 12 as shown in FIG. 6, allowing for communication of the discharge gas. Between the first row partition 15A and the bulked-up dielectric layer 12, a dielectric layer 17 is formed extending in a direction along the first row partition 15A in order to prevent discharge interference. Meanwhile, between the column partition 15C and the bulked-up dielectric layer 12, a dielectric layer 18 is formed intermittently in a direction along the column partition 15C, as shown in FIG. 7.

The region surrounded by the first row partition 15A and the column partition 15C (the region shown by the one-dot chain line in FIG. 5) is given as a pixel cell PC corresponding to a pixel. As shown in FIGS. 5 and 6, the pixel cell PC is divided as a display cell C1 and a select cell C2 by the second row partition 15B. The display cell C1 includes a pair of row electrodes X and Y corresponding to a display line and a fluorescent layer 16, as shown in FIGS. 5 and 6. The select cell C2 includes a row electrode Y of one pair of row electrodes corresponding to a display line, a row electrode X of one pair of row electrodes corresponding to a display line adjacent above to the display line of the display surface, a bulked-up dielectric layer 12 and a secondary-electron emitting material layer 30. Incidentally, within the display cell C1, oppositely arranged are the widened portion formed at one end of the transparent electrode Xa of the row electrode X and the widened portion formed at one end of the transparent electrode Ya of the row electrode Y, through a discharge gap g. The select cell C2 includes the widened portion formed at the other end of the transparent electrode Ya. The select cell C2 does not include the transparent electrode X.

As shown in FIG. 6, the respective discharge spaces of the adjacent pixel cells PC that are adjacent to each other with respect to the vertical (left-right in FIG. 6) direction of the display surface are shielded by the first row partition 15A and dielectric layer 17. The respective discharge spaces of the display cell C1 and the select cell C2 that are belong to the same pixel cell PC are in communication through a gap r, as shown in FIG. 6. The respective discharge spaces of the mutually adjacent select cells C2 with respect to the left-right direction of the display surface are shielded by the bulked-up dielectric layer 12 and dielectric layer 18, as shown in FIG. 7. However, the respective discharge spaces of the mutually adjacent display cells C1 with respect to the left-right direction of the display surface are in communication with each other. The pixel cells PC formed in the PDP 50 are each structured with a display cell C1 and a select cell C2 which have the respective discharge spaces in communication with each other.

As shown in FIG. 4, on the front transparent substrate 10 of PDP 50, there is mounted an odd-X electrode driver 51a, even-X electrode driver 51b, odd-Y electrode driver 53a, even-Y electrode driver 53b and address driver 55 in order to apply various drive pulses to the column electrodes D₁-Dₘ, row electrodes X₁-Xₙ and row electrodes Y₁-Yₙ. As shown in FIG. 4, the even-X electrode driver 51b and the even-Y electrode driver 53b are mounted at a right end on the front transparent substrate 10. Meanwhile, the odd-X electrode driver 51a and the odd-Y electrode driver 53a are mounted at a left end on the front transparent substrate 10. The odd-X electrode driver 51a is electrically connected to the connection terminal T_{XO} provided at the left end of the display electrode-formed portion DE, while the even-X electrode driver 51b is electrically connected to the connection terminal T_{XE} provided at the right end of the display electrode-formed portion DE. The odd-Y electrode driver 53a is electrically connected to the connection terminals T_{Y1}, T_{Y3}, T_{Y5}, . . . , T_{Y(n-3)} and T_{Y(n-1)} provided at the left end of the display electrode-formed portion DE. Furthermore, the even-Y electrode driver 53b is electrically connected to the connection terminals T_{Y2}, T_{Y4}, . . . , T_{Y(n-2)} and T_{Y(n)} provided at the right end of the display electrode-formed portion DE.

The odd-X electrode driver 51a applies various drive pulses (referred later) simultaneously to the odd-numbered row electrodes X₁, X₃, X₅, . . . , Xₙ₋₃ and Xₙ₋₁ of the PDP 50 through the connection terminal T_{XO}, according to a timing signal supplied from the drive control circuit 56. The even-X electrode driver 51b applies various drive pulses (referred later) simultaneously to the even-numbered row electrodes X₂, X₄, . . . , Xₙ₋₂ and Xₙ through the connection terminal T_{XE}, according to a timing signal supplied from the drive control circuit 56. The odd-Y electrode driver 53a applies separately various drive pulses (referred later) respectively to the odd-numbered row electrodes Y₁, Y₃, Y₅, . . . , Yₙ₋₃ and Yₙ₋₁ through the connection terminals T_{Y1}, T_{Y3}, T_{Y5}, . . . , T_{Y(n-3)} and T_{Y(n-1)}, according to a timing signal supplied from the drive control circuit 56. The even-Y electrode driver 53b applies separately various drive pulses (referred later) respectively to the even-numbered row electrodes Y₂, Y₄, Y₆, . . . , Yₙ₋₂ and Yₙ through the connection terminals T_{Y2}, T_{Y4}, . . . , T_{Y(n-2)} and T_{Y(n)}, according to a timing signal supplied from the drive control circuit 56. The address driver 55 applies a pixel data pulse (referred later) to the column electrode D₁-Dₘ of PDP 50, according to a timing signal supplied from the drive control circuit 56.

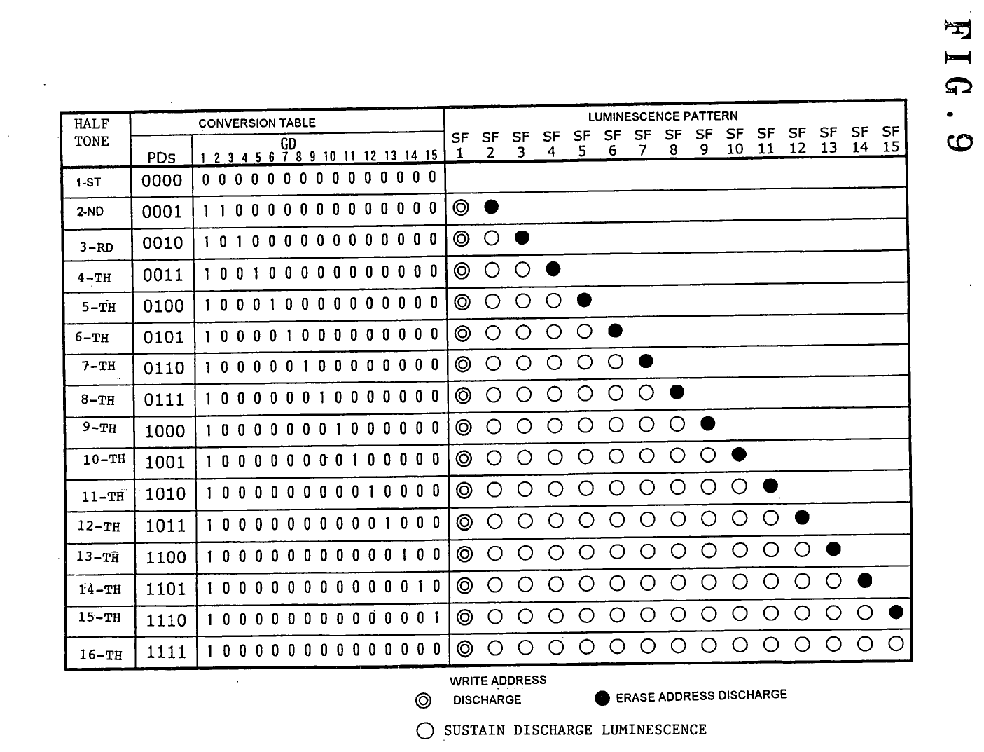

The drive control circuit 56 converts the input video signal into, for example, 8-bit pixel data representative of a luminance level on each pixel and carries out an error dispersion process and dither process on the image data. For example, in the error dispersion process, firstly the higher 6 bits of the pixel data are taken as display data and the remaining lower 2 bits as error data. The error data of the image data corresponding to each peripheral pixel is summed up by weighting into reflection in the display data. By this operation, the luminance in an amount of the lower 2 bits of the original pixel is expressed by the peripheral pixels in a simulation fashion. Therefore, by use of display data in an amount of 6 bits less than 8 bits, luminance tonal expression is made feasible equivalent to the pixel data in an amount of 8 bits. Dither process is carried out on 6-bit error-diffused pixel data obtained by the error dispersion process. In the dither process, a plurality of mutually adjacent pixels are taken as one pixel unit, the error diffused pixel data corresponding to each pixel of the one pixel unit are added by respectively assigning dither coefficients different in value, thereby obtaining dither addition pixel data. According to such dither coefficient addition, it is possible to express a luminance corresponding to 8 bits by use of the higher 4 bits only of the dither addition pixel data as seen on the 1-pixel unit basis. For this reason, the drive control circuit 56 takes the higher 4 bits of dither addition pixel data as multi-toned pixel data PDs. This is converted into 15-bit image drive data GD comprising the first to 15-th bit according to a data conversion table shown in FIG. 9. Accordingly, the pixel data capable of expressing 256 levels by 8 bits is converted into totally 16 patterns of 15-bit pixel drive data GD. Next, the drive control circuit 56 separates the pixel drive data GD_{1,1}-GD_{n,m} at the same bit place, based on pixel drive data GD_{1,1}-GD_{n,m} in an amount of one screen, thereby obtaining pixel drive data bit group DB1-DB15 as follows.
DB1: 1-st bit of each of pixel drive data GD_{1,1}-GD_{n,m}
DB2: 2-nd bit of each of pixel drive data GD_{1,1}-GD_{n,m}
DB3: 3-rd bit of each of pixel drive data GD_{1,1}-GD_{n,m}
DB4: 4-th bit of each of pixel drive data GD_{1,1}-GD_{n,m}
DB5: 5-th bit of each of pixel drive data GD_{1,1}-GD_{n,m}
DB6: 6-th bit of each of pixel drive data GD_{1,1}-GD_{n,m}
DB7: 7-th bit of each of pixel drive data GD_{1,1}-GD_{n,m}
DB8: 8-th bit of each of pixel drive data GD_{1,1}-GD_{n,m}
DB9: 9-th bit of each of pixel drive data GD_{1,1}-GD_{n,m}
DB10: 10-th bit of each of pixel drive data GD_{1,1}-GD_{n,m}
DB11: 11-th bit of each of pixel drive data GD_{1,1}-GD_{n,m}
DB12: 12-th bit of each of pixel drive data GD_{1,1}-GD_{n,m}
DB13: 13-th bit of each of pixel drive data GD_{1,1}-GD_{n,m}
DB14: 14-th bit of each of pixel drive data GD_{1,1}-GD_{n,m}
DB15: 15-th bit of each of pixel drive data GD_{1,1}-GD_{n,m}

Note that the pixel drive data bit groups DB1-DB15 respectively correspond to sub-fields SF1-SF15, referred later. The drive control circuit 56, in each sub-field SF1-SF15, supplies the pixel drive data bit group DB corresponding to the relevant sub-field in an amount of one display line (m in the number) per time to the address driver 55.

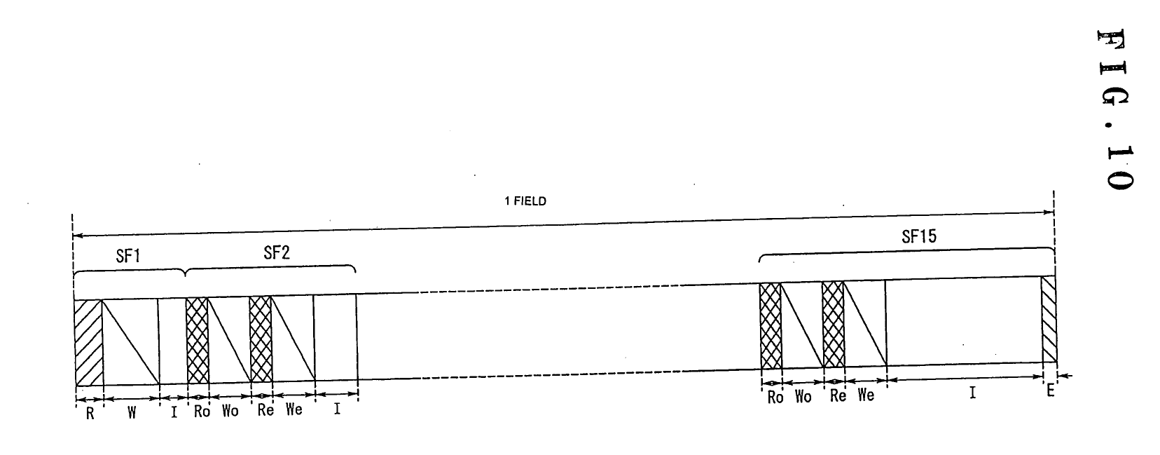

Furthermore, the drive control circuit 56 generates various timing signals for driving the PDP 50 according to a luminescent drive sequence as shown in FIG. 10 based on selective erase address method, and supplies those to the odd-X electrode driver 51a, the even-X electrode driver 51b, the odd-Y electrode driver 53a and the even-Y electrode driver 53b.

In the luminescence drive sequence shown in FIG. 10, each field of a video signal is divided into fifteen sub-fields SF1-SF15. In sub-field SF1, reset step R, selective write address step W and sustain step I are carried out in the order. In each of second sub-field SF2 to fifteenth sub-field SF15, reset step Ro, selective erase address Wo, reset step Re, selective erase address step We and sustain step I are carried out in the order. In the fifteenth sub-field SF15, erase step E is carried out immediately after the sustain step I. Incidentally, field is an expression for a video signal under the interlace scheme. Here, it is used as a unit display period for displaying an image in an amount of one screen.

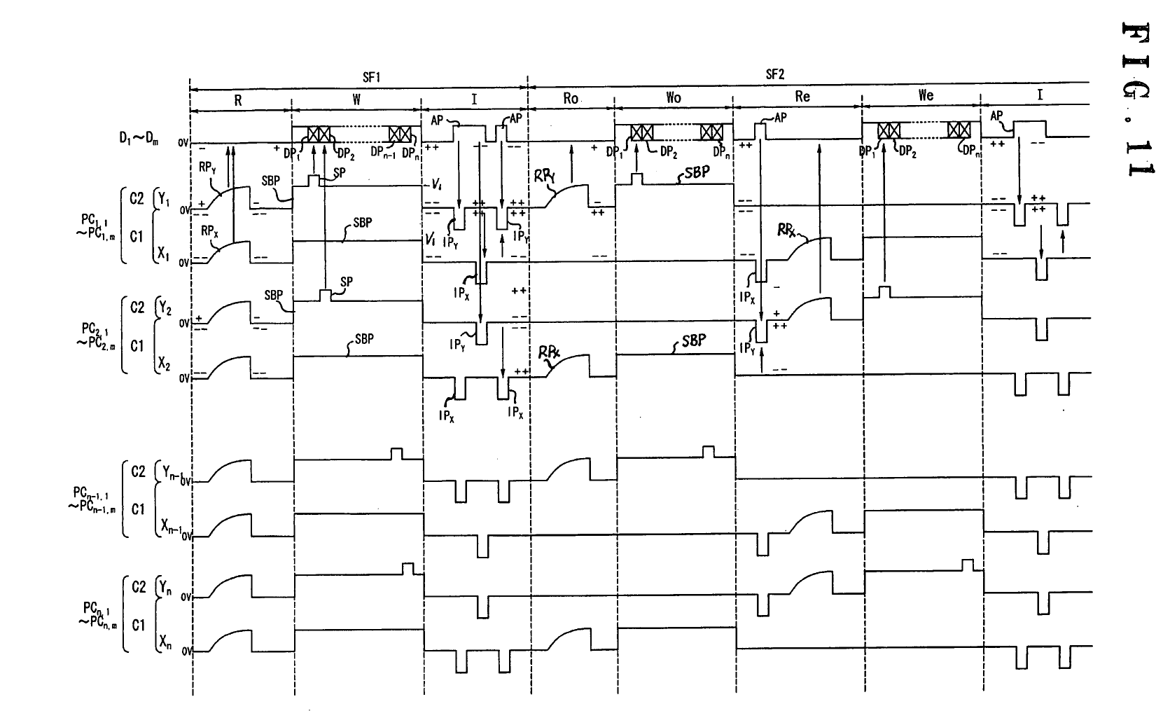

FIG. 11 is a figure showing various drive pulses that the address driver 55, the odd-X electrode driver 51a, the even-X electrode driver 51b, the odd-Y electrode driver 53a and the even-Y electrode driver 53b apply various drive pulses to the column electrode D and row electrode X and Y according to the luminescent drive sequence shown in FIG. 10. Note that FIG. 11 shows, by excerption, only the operation in the starting sub-fields SF1 and SF2 of the sub-fields SF1-SF15 shown in FIG. 10.

At first, the on-wall charge distribution state, immediately before reset step R in sub-field SF1, is negative in charge − on the column electrode D (D₁-Dₙ) and positive in charge + on the row electrode Y (Y₁-Yₙ) within the select cell C2, and negative in charge −− on the row electrode Y and positive in charge ++ on the row electrode X (X₁-Xₙ) within the display cell C1. Here, +, −, ++ and −− represent not only a positiveness/negativeness of on-wall charge but also an amount of on-wall charge. Namely, ++/−− represents greater in the amount of on-wall charge than +/−.

In reset step R in the first sub-field SF1, the odd-Y electrode driver 53a and the even-Y electrode driver 53b each generate a reset pulse RP_{Y} positive in polarity and moderate in rise and apply it simultaneously to the row electrodes Y₁-Yₙ. In timing with the reset pulse RPM, the odd-X electrode driver 51a and the even-X electrode driver 51b each generate a reset pulse RP_{X} positive in polarity and moderate in rise and apply it simultaneously to the row electrodes X₁-Xₙ.

In response to the application of reset pulses RP_{Y}, and RP_{X}, reset discharge is caused at between the column electrode D and the row electrode Y within each select cell C2 of every pixel cell PC of the PDP 50. After the reset discharge, on-wall charge + positive in polarity is formed on the column electrode D within the select cell C2 while on-wall charge − negative in polarity is formed on the row electrode Y. Meanwhile, on-wall charge −− negative in polarity is formed on the row electrode Y within the display cell C1 while on-wall charge −− negative in polarity is formed also on the row electrode X.

As noted above, in the reset step R under selective erase address method, reset discharge is caused at between the column electrode D and the row electrode Y within the select cell C2 of every pixel cell PC, to thereby cause on-wall charge in the foregoing state at the inside of the display cell C1 and select cell C2.

Next, in selective write address step W in sub-field SF1, the odd-Y electrode driver 53a and even-Y electrode driver 53b, while applying a scan base pulse SBP having a positive-polarity voltage V1 simultaneously to the row electrodes Y₁-Yₙ, applies a scan pulse SP having a waveform projecting from the scan base pulse SBP and a positive-polarity voltage V₂ (V₂>V₁) sequentially to the row electrodes Y₁-Yₙ. In this duration, the odd-X electrode driver 51a and even-X electrode driver 51b applies voltage V₁ to the row electrodes X₁-Xₙ. The address driver 55 converts each data bit of the pixel drive data bit group DB1 corresponding to the sub-field SF1 into a pixel data pulse DP having a pulse voltage commensurate with the logic level thereof. For example, the address driver 55, while converting a pixel drive data bit having logic level 0 into a pixel data pulse DP positive in polarity and high in voltage, converts a pixel drive data bit having logic level 1 into a low-voltage (0 volt) pixel data pulse DP. The pixel data pulse DP is applied in an amount of one display line (m in the number) per time to the column electrodes D₁-Dₘ, in synchronism with the application timing of the scan pulse SP. Namely, the address driver 55 first applies a pixel data pulse group DP1 comprising pixel data pulses DP in the number of m corresponding to the first display line to the column electrodes D₁-Dₘ. Then, it applies a pixel data pulse group DP2 comprising pixel data pulses DP in the number of m corresponding to the second display line to the column electrodes D₁-Dₘ.

Here, selective write address discharge is caused at between the column electrode D and the row electrode Y within the select cell C2 of the pixel cell PC to which the scan pulse SP and the low-voltage (0V) pixel data pulse DP are applied at the same time. In response to the selective write address discharge, on-wall charge ++ in positive polarity is formed on the row electrode D within the select cell C2 of the relevant cell PC while on-wall charge −− in negative polarity is formed on the row electrode Y within the select cell C2 thereof. Meanwhile, on-wall charge −− in negative polarity is formed on the row electrode Y within the display cell C1 while on-wall charge −− in negative polarity is formed also on the row electrode X. Meanwhile, because the pixel cell PC to be turn off is not applied by a low-voltage (0V) pixel data pulse DP, not causing selective write address discharge is not caused as was caused in the above. Accordingly, the on-wall charge distribution on the pixel cell PC remains in a state of immediately after ending the reset discharge.

Next, in sustain step I of each sub-field, the odd-Y electrode driver 53a repeatedly applies a sustain pulse IP_{Y} in negative polarity to odd-numbered row electrodes Y₁, Y₃, Y₅, . . . , Yₙ₋₃ and Yₙ₋₁. In the sustain step I, the even-Y electrode driver 53b applies a sustain pulse IP_{Y} in negative polarity to even-numbered row electrodes Y₂, Y₄, . . . , Yₙ₋₂ and Yₙ, in timing different from the timing of application to the odd-numbered row electrodes Y as noted above. In sustain step I, the odd-X electrode driver 51a repeatedly applies a sustain pulse IP_{X} in negative polarity to odd-numbered row electrodes X₁, X₃, X₅, . . . , Xₙ₋₃ and Xₙ₋₁, in timing with the sustain pulse IP_{Y} applied to the odd-numbered row electrodes Y as noted above. In the sustain step I, the even-X electrode driver 51b applies a sustain pulse IP_{X} in negative polarity to even-numbered row electrodes Y₂, Y₄, . . . , Yₙ₋₂ and Yₙ, in timing with the sustain pulse IP_{Y} applied to the odd-numbered row electrodes Y as noted above. Incidentally, the sustain pulse IPY and IP_{X} are applied in each sustain step I by the number of times assigned to the sub-field to which the relevant sustain step I belongs. The address driver 55 applies a positive-polarity address pulse AP to the column electrodes D₁-Dₙ, in synchronism with the application of the first sustain pulse IP_{Y} to be first applied within the sustain step. In response to applications of the first sustain pulse IP_{Y} and address pulse, discharge is caused at between the column electrode D and the row electrode Y within the select cell C2 of a pixel cell PC to turn on (turn-on mode).

By the discharge, on-wall charge −− in negative polarity is formed on the row electrode D within the select cell C2 while on-wall charge ++ in positive polarity is formed on the row electrode Y within the select cell C2. Namely, there is an inversion in polarity of the on-wall charge on the row electrode Y within the select cell C2. Furthermore, the discharge extends into the display cell C1 through the gap r of the pixel cell PC, to form on-wall charge ++ in positive polarity on the row electrode Y within the display cell C1. On this occasion, on-wall charge −− in negative polarity remains as it is on the row electrode Y within the display cell C1. Accordingly, due to the discharge, the pixel cell PC including the relevant display cell C1 is set to on-mode. Subsequently, each time sustain pulses IPX and IPY are alternately repeatedly applied the number of times corresponding to the sub-fields, sustain discharge (display discharge) is caused at between the row electrodes Y and X within the display cell C1, thus maintaining a discharge-based luminescent state.

Meanwhile, in the pixel cell PC to be turn off (turn-off mode), on-wall charge − in negative polarity is formed on the row electrode Y within the select cell C2 while on-wall charge + in positive polarity is formed on the column electrode D. Accordingly, even if the first sustain pulse IP_{Y} and the address pulse in synchronism therewith are applied, no discharge is caused at between the column electrode D and the row electrode Y within the select cell C2, resulting in no inversion in polarity of the on-wall charge. Thus, the pixel cell PC is set to turn-off mode. Subsequently, even if there is an application of sustain pulses IP_{X} and IP_{Y}, no sustain discharge (display discharge) is caused at between the row electrodes Y and X within the display cell C1, thus maintaining an off state.

Here, in timing with the sustain pulse IP_{Y} to be applied the last to the odd-numbered row electrode Y within each sustain step I, the address driver 55 again applies an address pulse AP in positive polarity to the column electrodes D₁-Dₘ. This causes a discharge at between the column electrode D and the row electrode Y within the select cell C2. Due to the discharge, on-wall charge −− in negative polarity is formed on the column electrode D within the select cell C2 while on-wall charge ++ in positive polarity is formed on the row electrode Y within the select cell C2. Within the display cell C1, by the sustain discharge caused between the row electrodes X and Y, on-wall charge ++ in positive polarity is formed on the row electrode Y while on-wall charge −− in negative polarity is formed on the row electrode X.

Next, in reset step Ro of each sub-field, the odd-Y electrode driver 53a generates a reset pulse RP, moderate in rise and positive in polarity and applies it simultaneously to the odd-numbered row electrodes Y₁, Y₃-Yₙ₋₁ of PDP 50. In timing with the reset pulse RP_{Y}, the even-X electrode driver 51b generates a positive-polarity reset pulse RP_{X} having the same waveform as the above reset pulse RP_{Y} and applies it simultaneously to the even-numbered row electrodes X₂, X₄-Xₙ of the PDP 50.

In the pixel cell PC belonging to the odd line where sustain discharge is caused in the sustain step I of immediately before the reset step Ro, reset discharge is caused at between the column electrode D and the row electrode Y within the select cell C2. After ending of the reset discharge, on-wall charge + in positive polarity is formed on the row electrode D within the select cell C2 the reset discharge is caused while on-wall charge − in negative polarity is formed on the row electrode Y. Meanwhile, on-wall charge ++ in positive polarity is maintained on the row electrode Y within the display cell C1 of the pixel PC belonging to the odd line while on-wall charge −− in negative polarity is maintained on the row electrode X.

Next, in selective erase address step Wo, the odd-X electrode driver 53a, while applying a scan base pulse SBP having a positive-polarity voltage V₁ to odd-numbered row electrodes Y₁, Y₃-Yₙ₋₁, applies a scan pulse SP having a waveform projecting from the scan base pulse SBP and a positive-polarity voltage V₂ sequentially to the odd-numbered row electrodes Y₁, Y₃-Yₙ₋₁. In this duration, the odd-X electrode driver 51b applies a scan base pulse SBP having a positive polarity voltage V₁ simultaneously to the even numbered row electrodes X₂, X₄-Xₙ. The application of a scan base pulse SBP by the odd-Y electrode driver 53a is simultaneous with the application of a scan base pulse SBP by the even-X electrode driver 51b. Furthermore, in this duration, the address driver 55 converts each data bit of the pixel drive data bit group DB1 corresponding to the sub-field into a pixel data pulse DP having a pulse voltage commensurate with the logic level thereof. For example, the address driver 55, while converting a pixel drive data bit having logic level 0 into a low-voltage (0 volt) pixel data pulse DP, converts a pixel drive data bit having logic level 1 into a pixel data pulse DP positive in polarity and high in voltage. This conversion is reverse in logic to that of the first sub-field. The pixel data pulse DP is applied in an amount of one display line (m in the number) per time to the column electrodes D₁-Dₘ, in synchronism with application timing of the scan pulse SP. Namely, the address driver 55 first applies a pixel data pulse group DP₁ comprising pixel data pulses DP in the number of m corresponding to the first display line to the column electrodes D₁-Dₘ. Then, it applies a pixel data pulse group DP₂ comprising pixel data pulses DP in the number of m corresponding to the second display line to the column electrodes D₁-Dₘ.

Here, selective erase address discharge is caused at between the column electrode D and the row electrode Y within the select cell C2 of the pixel cell PC to which the scan pulse SP and the low-voltage (0V) pixel data pulse DP are applied at the same time. After the selective erase address discharge, on-wall charge + in positive polarity is formed on the row electrode D within the select cell C2 of the odd-lined pixel cell PC to be put off while on-wall charge − in negative polarity is formed on the row electrode Y. Meanwhile, on-wall charge −− in negative polarity is formed on the row electrode Y within the display cell C1 of the odd-lined pixel cell PC while on-wall charge −− in negative polarity is formed also on the row electrode X. Meanwhile, because the pixel cell PC to be put off is not applied by a pixel data pulse DP, there is no occurrence of selective write address discharge. Accordingly, the on-wall charge distribution on the pixel cell PC remains in a state of immediately after ending the reset discharge. Namely, the positive-polarity on-wall charge ++ is maintained on the row electrode Y within the display cell C1 while the negative-polarity on-wall charge −− is maintained on the row electrode X. Due to this, the pixel cell PC is set to turn-on mode.

In this manner, by the execution of selective erase address step Wo, the pixel cells PC of all the pixel cells PC belonging to the odd line of the PDP 50 are each set to any one state of turn-on mode and turn-off mode according to pixel data.

Next, in reset step Re of each sub-field, the even-Y electrode driver 53b applies a sustain pulse IP_{Y} in negative polarity simultaneously to the even-numbered row electrodes Y₂, Y₄-Y of the PDP 50. Simultaneously with this, the odd-X electrode driver 51a applies a sustain pulse IP_{X} in negative polarity simultaneously to the odd-numbered row electrodes X₁, X₃, X₅, . . . , Xₙ₋₃ and Xₙ₋₁. In synchronism with the sustain pulse IP_{Y} and IP_{X}, the address driver 55 applies a positive-polarity address pulse AP to the column electrodes D₁-Dₘ. As a result, discharge is not caused in the pixel cells PC set in turn-off mode, to maintain the turn-off mode state. Meanwhile, in the pixel cells PC set in turn-on mode, discharge is caused in each of the display cell C1 and select cell C2 of the pixel cell PC belonging to the even line. By the discharge, on-wall charge + in positive polarity is formed on the row electrode Y within the select cell C2 while on-wall charge − in negative polarity is formed on the row electrode D within the select cell C2. Furthermore, on-wall charge + in positive polarity is formed on the row electrode Y within the display cell C1 while on-wall charge −− in negative polarity is formed on the row electrode X within the display cell C1. Thereafter, the even-Y electrode driver 53b generates a reset pulse RP_{Y} moderate in rise and positive in polarity and applies it simultaneously to the even-numbered row electrode Y₂, Y₄-Yₙ of PDP 50. Meanwhile, in timing with the reset pulse RP_{Y}, the odd-X electrode driver 51a generates a reset pulse RP_{X} positive in polarity and applies it simultaneously to the odd-numbered row electrode X₁, X₃-Xₙ₋₁ of PDP 50. In response to the application of these reset pulses RP_{Y} and RP_{X}, weak reset discharge is caused at between the column electrode D and the row electrode Y within the select cell C2 of the pixel cell PC belonging to the even line where a sustain discharge has been caused in the immediately preceding sustain step I. After ending the reset discharge, on-wall charge + in positive polarity is formed on the column electrode D within the select cell C2 where the reset discharge has been caused while on-wall charge − in negative polarity is formed on the row electrode Y. Meanwhile, on-wall charge ++ in positive polarity is formed on the row electrode Y within the display cell C1 of the pixel cell PC belonging to the even line while on-wall charge −− in negative polarity is maintained on the row electrode X.

Next, in selective erase address step We, the even-Y electrode driver 53b, while applying a scan base pulse SBP having a positive-polarity voltage V₁ to even-numbered row electrodes Y₂, Y₄-Yₙ, applies a scan pulse SP having a waveform projecting from the scan base pulse SBP and a positive-polarity voltage V₂ sequentially to the even-numbered row electrodes Y₂, Y₄-Yₙ. The odd-X electrode driver 51a applies a scan base pulse SBP having a positive-polarity voltage V₁ simultaneously to the odd numbered row electrodes X₁, X₃-Xₙ₋₁. The address driver 55 converts each data bit of the pixel drive data bit group DB₁ corresponding to each sub-field into a pixel data pulse DP having a pulse voltage commensurate with the logic level thereof. The pixel data pulse DP is applied in an amount of one display line (m in the number) per time to the column electrodes D₁-Dₘ, in synchronism with application timing of the scan pulse SP. Namely, the address driver 55 first applies a pixel data pulse group DP1 comprising pixel data pulses DP in the number of m corresponding to the first display line to the column electrodes D₁-Dₘ. Then, it applies to the column electrodes D₁-Dₘ a pixel data pulse group DP₂ comprising pixel data pulses DP in the number of m corresponding to the second display line. On this occasion, selective erase address discharge is caused at between the column electrode D and the row electrode Y within the select cell C2 of the pixel cell PC to which the scan pulse SP and the low-voltage (0 volt) pixel data pulse are applied at the same time. After the selective erase address discharge, on-wall charge + in positive polarity is formed on the column electrode D within the select cell C2 of the pixel cell PC on the even line to be turn off, while on-wall charge − in negative polarity is formed on the row electrode Y. Meanwhile, on-wall charge −− in negative polarity is formed on the row electrode Y within the display cell C1 of the pixel cell PC belonging to the even line, while on-wall charge −− in negative polarity is also formed on the row electrode X. Due to this, the pixel cell PC is set to turn-off mode. On the other hand, because the low-voltage (0 volt) pixel data pulse DP is not applied to the pixel cell PC belonging to the even line to turn on, no selective erase address discharge is caused therein. Accordingly, the pixel cell PC is in an on-wall charge distribution state remaining in a state of immediately after ending reset discharge in the reset step Re. Namely, positive polarity on-wall charge ++ is maintained on the row electrode Y within the display cell C1 while negative polarity on-wall charge −− is maintained on the row electrode X. Due to this, the pixel cell PC is set to turn-on mode.

In this manner, by executing the above selective erase address step We, the pixel cells PC belonging to the even line of among all the pixel cells PC of the PDP 50 are set to any one state of turn-on mode and turn-off mode according the pixel data.

After executing the selective erase address step We, sustain step I is carried out in the foregoing manner. Trickle discharge is repeatedly done the number of times assigned to each sub-field, only in the pixel cell PC set in turn-on mode. The luminescent state due to the discharge is maintained.

The driving shown in FIGS. 10 and 11 as described above is carried out on the basis of the pixel drive data GD in 16 ways as shown in FIG. 9. According to the driving, write address discharge is caused (shown at the double circle) within the pixel cell PC in selective write address step W of the first sub-field SF1 excepting for the case to represent a luminance level 0 (first gray-scale), as shown in FIG. 9. Thus, the pixel cell PC is set to turn-on mode. Thereafter, selective erase address discharge is caused (shown at solid circle) only in selective erase address step Wo and We of one of sub-fields SF2-SF15, to set the pixel cell PC to turn-off mode. Namely, each pixel cell PC is set to turn-on mode in the sub-fields continuing in the number corresponding to an halfway intensity level to express. Luminescence is repeatedly caused (shown at open circle) due to sustain discharge by the number of times assigned to each of these sub-fields. On this occasion, visual perception is at a luminance corresponding to the total number of luminescence due to the sustain discharge caused within one field. Accordingly, according to 16 kinds of luminescence patterns based on driving with first to sixteenth gray-scale as shown in FIG. 9, 16 levels of halftone can be expressed corresponding to the total number of times of sustain discharge caused in the sub-fields shown by the open circles.

In the plasma display device shown in FIG. 4, the pixel cell PC corresponding to a pixel for the PDP 50 is constructed by a display cell C1 and a select cell C2 as shown in FIGS. 5 and 6. The sustain discharge as involved in a display image is caused within the display cell Cl whereas reset and address discharge for luminescence not involved in a display image is caused mainly within the select cell C2. Within the select cell C2, a bulked-up dielectric layer 12 is formed by a light-absorbing layer containing a black or dark-color pigment, in order to prevent the light resulting from reset and address discharge from leaking to the outside through the front transparent substrate 10. Accordingly, the discharge light caused by reset and address discharge is shut off by the bulked-up dielectric layer 12, hence making it possible to enhance the contrast, particularly dark contrast, of a display image. Meanwhile, within the select cell C2, a secondary electron emitting material layer 30 is provided on the side close to the back substrate 13, as shown in FIG. 6. The secondary electron emitting material layer 30 has a well γ-characteristic for emitting secondary electrons during discharge wherein the formed surface thereof acts as a cathode. On this occasion, in each address step (W, Wo, We) shown in FIG. 11, address discharge is caused by applying a scan pulse SP having a positive-polarity voltage V₂ to the row electrode Y and, further, a low-voltage (0 volt) pixel data pulse DP to the column electrode D. Namely, address discharge is caused by taking the column electrode D as a cathode side. Accordingly, the secondary electron emitting material layer 30 formed within the select cell C2 is also rendered as a cathode, to favorably emit second electrons from the secondary electron emitting material layer 30. Thus, address discharge is to be positively caused within the select cell C2.

Furthermore, the PDP 50 shown in FIG. 4 is structured that the connection terminal T_{XO} to which odd-numbered row electrodes X₁, X₃, . . . , Xₙ₋₁ are commonly connected is provided at a left end of the display electrode-formed portion DE. The PDP50 structured that the connection terminal T_{XE} to which even-numbered row electrodes X₂, X₄, . . . , Xₙ are commonly connected is provided at a right end of the display electrode-formed portion DE. Furthermore, the PDP 50 is structured that the connection terminals T_{Y1}, T_{Y3}, . . . , T_{Y(n-1)} to which odd-numbered row electrodes Y₁, Y₃, . . . , Yₙ₋₁ are separately respectively connected are provided at a left end of the display electrode-formed portion DE. The PDP 50 is structured that the connection terminals T_{Y2}, T_{Y4}, . . . , T_{Y(n)} to which even-numbered row electrodes Y₂, Y₄, . . . , Yₙ₋₂ and Yₙ are separately respectively connected are provided at a right end of the display electrode-formed portion DE.

The odd-X electrode driver 5la and the odd-Y electrode driver 53a are mounted at a left end of the front transparent substrate 10 of the PDP 50. Through the connection terminals T_{Y1}, T_{Y3}, . . . , T_{Y(n-1)} of the display electrode-formed portion DE, the odd-Y electrode driver 53a is electrically connected with the odd-numbered row electrodes Y₁, Y₃, . . . , Yₙ₋₁. Furthermore, through the connection terminal T_{XO} of the display electrode-formed portion DE, the odd-X electrode driver 51a is electrically connected with the odd-numbered row electrodes X₁, X₃, . . . , Xₙ₋₁. Furthermore, The even-X electrode driver 51b and the even-Y electrode driver 53b are mounted at a right end of the front transparent substrate 10 of the PDP 50. In this case, through the connection terminals T_{Y2}, T_{Y4}, . . . , T_{Y(n)} of the display electrode-formed portion DE, the even-Y electrode driver 53b is electrically connected with the even-numbered row electrodes Y₂, Y₄, . . . , Yₙ. Furthermore, through the connection terminal T_{XE} of the display electrode-formed portion DE, the even-X electrode driver 51b is electrically connected with the even-numbered row electrodes X₂, X₄, . . . , Xₙ₋₂ and Xₙ.

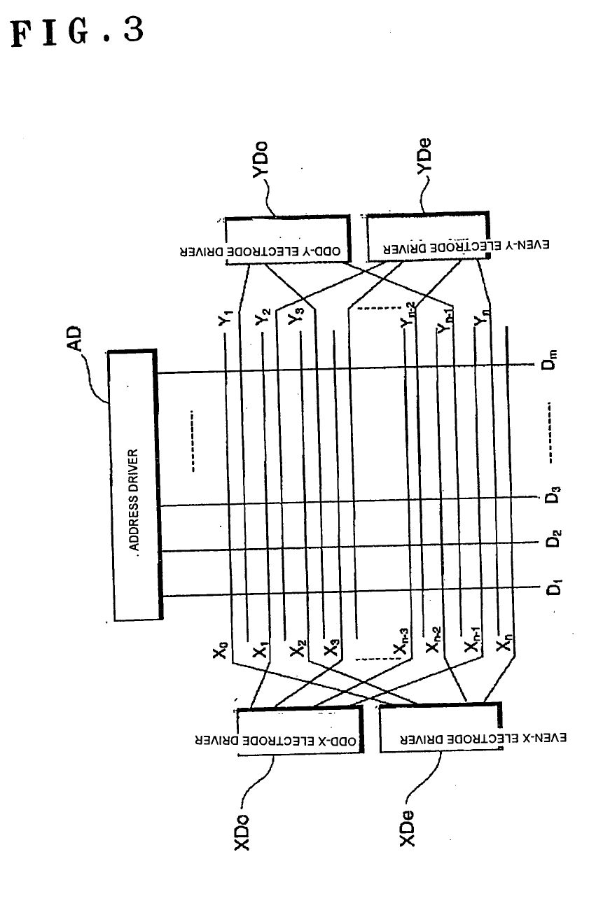

According to the PDP 50 as above, there are a reduced number of crossing points of electric connection lines between the odd-X electrode driver 51a, odd-Y electrode driver 53a, odd-X electrode driver 51b and even-Y electrode driver 53b and the display electrode-formed portion DE, as compared to the case adopting such a structure as shown in FIG. 3.

Accordingly, the interconnect form reduces the floating capacitance existing between the lines, to reduce the consumption of ineffective power due to ineffective charge/discharge to/from the floating capacitance. Furthermore, there is the reduced probability to cause such failures as migration, insufficient breakdown voltage or the like at between the connection terminal with the row electrode belonging to the odd display line and the connection terminal with the row electrode belonging to the even display line.

In this manner, the present invention allows for driving the display panel under favorable conditions.

Incidentally, in the embodiment shown in FIG. 4, the connection terminals T_{Y1}, T_{Y3}, . . . , T_{Y(n-1)} and T_{XO} for connection to odd-numbered row electrodes Y and X are provided at a left end of the display electrode-forming region DE while the connection terminals T_{Y2}, T_{Y4}, . . . , TY(n) and T_{XE} for connection to even-numbered row electrodes Y and X are provided at a right end of the display electrode-forming region DE. This however is not limitative. For example, the connection terminals T_{Y1}, T_{Y3}, . . . , T_{Y(n-1)} and T_{XO} may be provided at a right end of the display electrode-formed portion DE while the connection terminals T_{Y2}, T_{Y4}, . . . , T_{Y(n)} and T_{XE} may be provided at a left end of the display electrode-formed portion DE. In this case, the even-X electrode driver 51b and the even-Y electrode driver 53b are mounted at a right end on the front transparent substrate 10 while the odd-X electrode driver 51a and the odd-Y electrode driver 53a are mounted at a left end on the front transparent substrate 10.

In brief, it is satisfactory to provide, at one end in the row direction on the transparent substrate, a connection terminal for connection of odd-numbered row electrode Y and X of among the row electrodes X₁-Xₙ and Y₁-Yₙ formed extending in the row direction on the front transparent substrate and, at the other end, a connection terminal for connection of even-numbered row electrode Y and X. Furthermore, it is satisfactory to mount, at one end on the front substrate, a driver for applying a drive pulse to the odd-numbered row electrodes X and Y and, at the other end on the front substrate, a driver for applying a drive pulse to the even-numbered row electrodes X and Y.

In the above embodiment, driving is carried out to cause reset and address discharge by taking the column electrode D relatively as a negative side as shown in FIG. 11 and to cause sustain discharge by applying a negative-polarity sustain impulse IP alternately within each pixel cell PC of the PDP 50. However, driving may be on the inverted polarities. Namely, the column electrode D is taken relatively positive in polarity to thereby cause reset and address discharge so that sustain discharge can be caused by alternately applying a positive-polarity sustain pulse IP.

Although FIG. 4 showed one example employing the arrangement of X-Y, X-Y, X-Y, X-Y as an arrangement of row electrode pairs corresponding to the first to n-th display lines of the PDP 50, it may adopt an arrangement like X-Y, Y-X, X-Y, Y-X. In this case, the select cell C2 of a pixel cell PC belonging to the odd line-is adjacent to the select cell C2 of a pixel cell PC belonging to the even line. With this arrangement structure, the drive pulses to be applied to the row electrodes Y can be given in the same phase while the drive pulses to be applied to the row electrodes X be given in the same phase. Accordingly, in sub-fields SF2-SF15 shown in FIG. 10, there is no need to separate in time between the reset and selective erase address operation for the pixel cells PC belonging to the odd display line and the reset and selective erase address operation for the pixel cells PC belonging to the even display line.

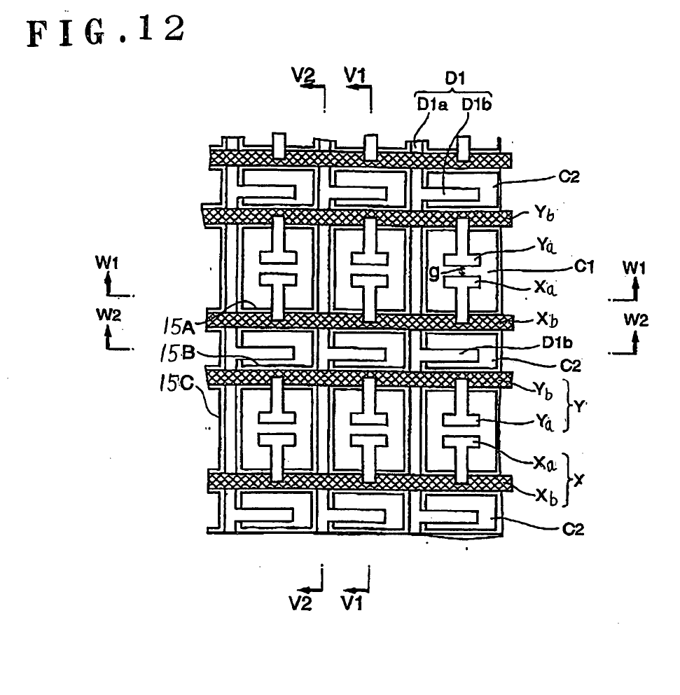

Meanwhile, in the above embodiment, the pixel cell which employed the structure shown in FIGS. 5 to 8, may adopt a structure as shown in FIGS. 12 to 16, for example.

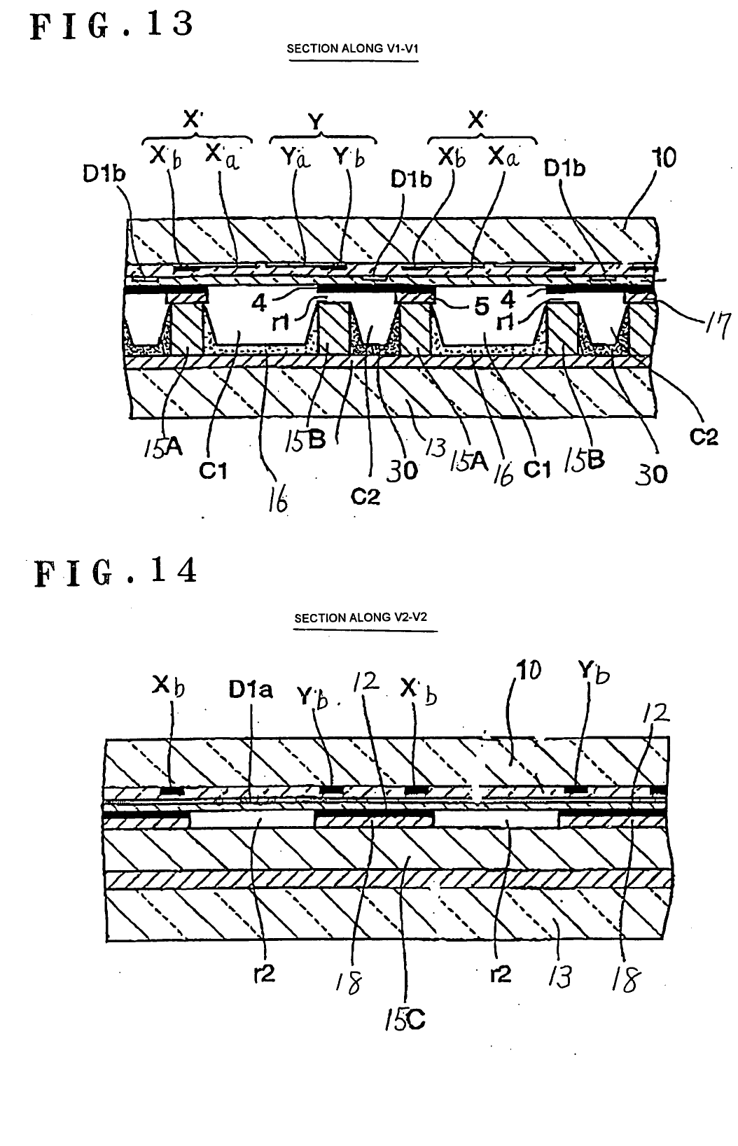

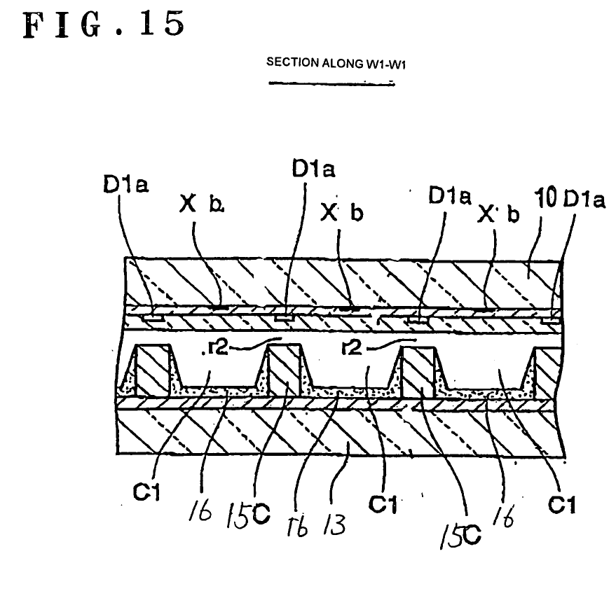

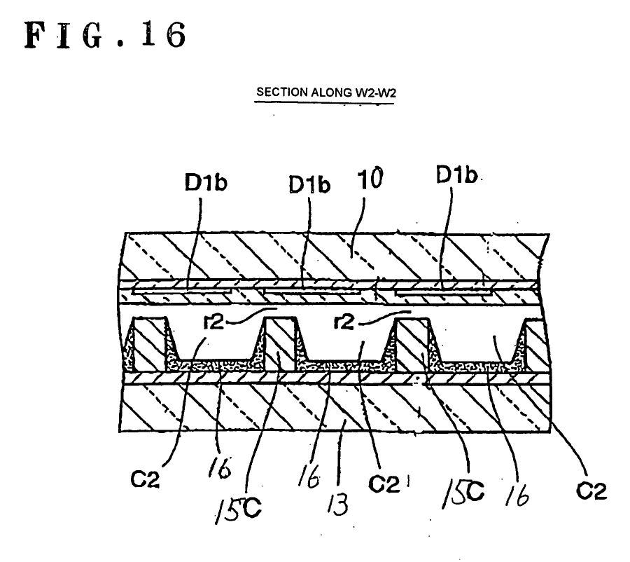

FIG. 12 is a plan view of the display electrode-formed portion DE of the PDP 50 as viewed from a display surface side. FIG. 13 is a sectional view of the same as viewed from the line V1-V1 shown in FIG. 12. FIG. 14 is a sectional view of the same as viewed from the line V2-V2 shown in FIG. 12. FIG. 15 is a sectional view of the same as viewed from the line W1-W1 shown in FIG. 12. FIG. 16 is a sectional view of the same as viewed from the line W2-W2 shown in FIG. 12.

Note that, in FIGS. 12 to 16, the same structure as the structure depicted in FIGS. 5 to 8 is attached with the same reference.

In the structure shown in FIGS. 12 to 16, the row electrodes D are provided, together with the row electrodes X and Y, on the front transparent substrate 10. The column electrode D is constituted by a main electrode portion D1a in a strip form extending in the column (vertical) direction of the display surface and a projection electrode portion D1b projecting in the row (left-right) direction of the display surface from the main electrode portion D1a within each select cell C2. The main electrode portion D1a is arranged in a manner superposed over a column partition 15C as shown in FIG. 15. Reset and address discharge is caused at between the main electrode portion D1a and a bus electrode Yb of within the select cell C2.

Although the above embodiment showed the example on an application to the PDP having a cell structure configuring the unit luminescent region by the display cell C1 as the first discharge cell and the display cell C2 as the second discharge cell, the PDP structure is not limited to such a structure. For example, application is possible to a PDP having a structure that the row electrode X, Y comprising a display line has a polarity and direction of discharge wherein the polarity and direction is in the same direction on all the even and odd display lines (e.g. structure alternately arranging a row electrode X to which a sustain pulse is to be applied and a row electrode Y to which a sustain pulse and a scan pulse are to be applied).

In the embodiment shown in FIG. 4, a display electrode-formed portion DE is provided, at one end, with connection terminals of the electrodes in odd-numbered arrangement of among row electrodes X₁-Xₙ and Y₁-Yₙ and, at the other end, with connection terminals of the electrodes in even-numbered arrangement. However, the connection terminal of the odd-numbered row electrodes X and the connection terminal of the even-numbered row electrodes Y may be provided at one end of the display electrode-formed portion DE while the connection terminal of the even-numbered row electrodes X and the connection terminal of the odd-numbered row electrodes Y be provided at the other end of the display electrode-formed portion DE.

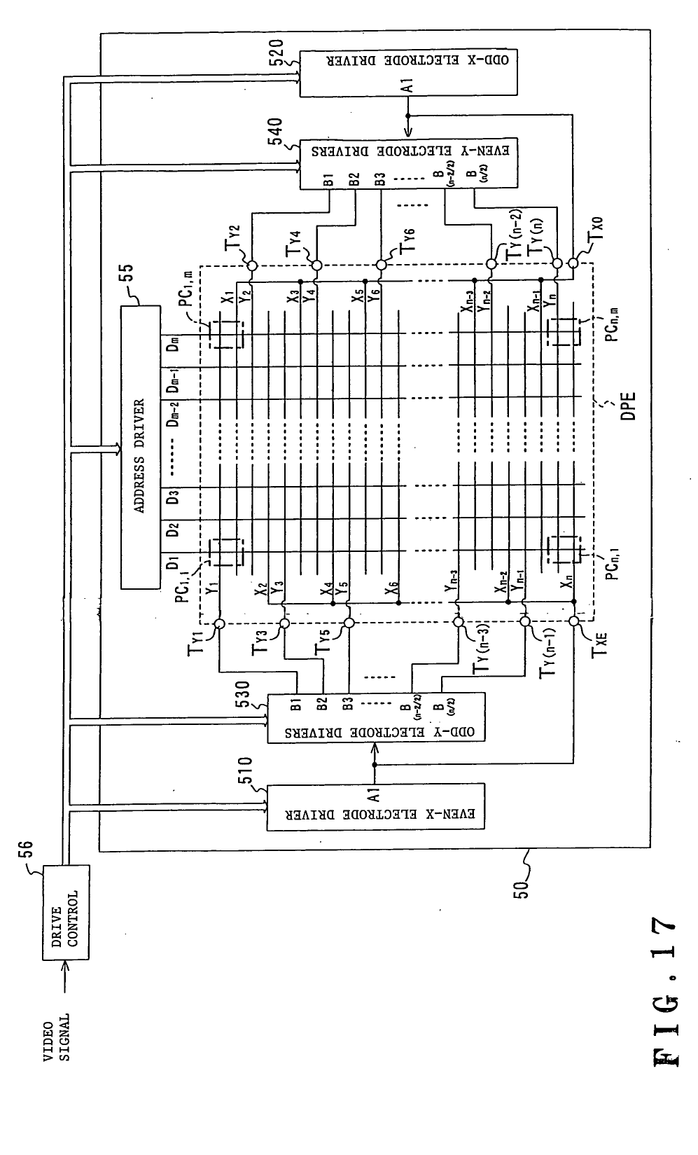

FIG. 17 is a diagram showing another arrangement of a plasma display device as a display device of the invention made in view of such a point.

In FIG. 17, a drive control circuit 56 and an address driver 55 are the same in function as those shown in FIG. 4. Hence, the operation is omitted to explain.

Meanwhile, the pixel cells PC shown in FIG. 17, which are formed in the display electrode-formed region DPE at intersections of line-formed row electrodes D₁-Dₘ and row electrodes X₁-Xₙ and Y₁-Yₙ as well as pairs of row electrodes X and Y and column electrodes D, are the same as those shown in FIG. 4. Furthermore, within the display electrode-formed region DPE, the row electrodes X₁-Xₙ and Y₁-Yₙ are arranged in such a form as Y-X, Y-X (or X-Y, X-Y) similarly to the case of the display electrode-formed portion DE shown in FIG. 4.

However, the display electrode-formed region DPE is formed therein with a connection terminal T_{XO} commonly connected to the odd-numbered row electrodes X₁, X₃, X₅, . . . , Xₙ₋₁ and connection terminals T_{Y2}, T_{Y4}, . . . , T_{Y(n)} respectively connected to the even-numbered row electrodes Y₂, Y₄, . . . , Yₙ, at a right end of the display electrode-formed region DPE. Furthermore, there are formed a connection terminal T_{XE} commonly connected to the even-numbered row electrodes X₂, X₄, . . . , Xₙ and connection terminals T_{Y1}, T_{Y3}, . . . , T_{Y(n-1)} respectively connected to the odd-numbered row electrodes Y₁, Y₃, . . . , Yₙ₋₁, at a left end of the display electrode-formed region DPE.

The display electrode-formed region DPE is fixed on a chassis (not shown) of the PDP 50. The address driver 55 is mounted on the chassis, in a position close to the upper end of the display electrode-formed region DPE. An even-X electrode driver 510 and an odd-Y electrode driver 530 are mounted on the chassis, in a position close to the left end of the display electrode-formed region DPE. Furthermore, an odd-X electrode driver 520 and an even-Y electrode driver 540 are mounted on the chassis, in a position close to the right end of the display electrode-formed region DPE. The even-X electrode driver 510 has an output terminal Al electrically connected to the odd-Y electrode driver 530 and the connection terminal T_{XE} of the display electrode-formed region DPE. The odd-Y electrode driver 530 has output terminals B1-B(2/n) respectively electrically connected to the connection terminals T_{Y1}, T_{Y3}, . . . , T_{Y(n-1)} of the display electrode-formed region DPE through a single connection line. The odd-X electrode driver 520 has an output terminal Al electrically connected to the even-Y electrode driver 540 and the connection terminal T_{XO} of the display electrode-formed region DPE. The even-Y electrode driver 540 has output terminals B1-B(n/2) respectively electrically connected to the connection terminals T_{Y2}, T_{Y4}, . . . , T_{Y(n)} of the display electrode-formed region DPE through a single connection line.

The even-X electrode driver 510, in the reset step R or Ro, generates a reset pulse RP_{X} as shown in FIG. 11 and applies it to the even-numbered row electrode X₂, X₄, . . . , Xₙ of the display electrode-formed region DPE. The even-X electrode driver 510, in the sustain step I, generates a sustain pulse IP_{X} as shown in FIG. 11 and applies it to the even-numbered row electrode X₂, X₄, . . . , Xₙ. Furthermore, the even-X electrode driver 510 supplies the reset pulse RP_{X} or the sustain pulse IP_{X} to the odd-Y electrode driver 530. The odd-Y electrode driver 530, when a reset pulse RP_{X} is supplied from the even-X electrode driver 510 in the reset step R or Ro, applies it as it is, as a reset pulse RP_{Y} to the odd-numbered row electrodes Y₁, Y₃, Y₅, . . . , Yₙ₋₁ of the display electrode-formed region DPE, as shown in FIG. 11. The odd-Y electrode driver 530, when a sustain pulse IP_{X} is supplied from the even-X electrode driver 510 in the sustain step I, applies it as it is, as a sustain pulse IP_{Y} to the odd-numbered row electrodes Y₁, Y₃, Y₅, . . . , Yₙ₋₁ of the display electrode-formed region DPE, as shown in FIG. 11. Furthermore, the odd-Y electrode driver 530, in the selective write address step W or selective erase address step Wo, generates a scanning pulse SP as shown in FIG. 11 and applies it sequentially to the odd-numbered row electrode Y₁, Y₃, Y₅, . . . , Yₙ₋₁, of the display electrode-formed region DPE.

The odd-X electrode driver 520, in the reset step R or Ro, generates a reset pulse RP_{X} as shown in FIG. 11 and applies it to the odd-numbered row electrode X₁, X₃, X₅, . . . , Xₙ₋₁ of the display electrode-formed region DPE. The odd-X electrode driver 520, in the sustain step I, generates a sustain pulse IP_{X} as shown in FIG. 11 and applies it to the odd-numbered row electrode X₁, X₃, X₅, . . . , Xₙ₋₁. Furthermore, the odd-X electrode driver 520 supplies the reset pulse RP_{X} or the sustain pulse IP_{X} to the even-Y electrode driver 540. The even-Y electrode driver 540, when a reset pulse RP_{X} is supplied from the odd-X electrode driver 520 in the reset step R or Ro, applies it as it is, as a reset pulse RP_{Y} to the even-numbered row electrodes Y₂, Y₄, . . . , Yₙ of the display electrode-formed region DPE, as shown in FIG. 11. The even-Y electrode driver 540, when a sustain pulse IP_{X} is supplied from the odd-X electrode driver 520 in the sustain step I, applies it as it is, as a sustain pulse IP_{Y} to the even-numbered row electrodes Y₂, Y₄, . . . , Yₙ of the display electrode-formed region DPE, as shown in FIG. 11. Furthermore, the even-Y electrode driver 540, in the selective write address step W or selective erase address step Wo, generates a scanning pulse SP as shown in FIG. 11 and applies it sequentially to the even-numbered row electrode Y₂, Y₄, . . . , Yₙ of the display electrode-formed region DPE.

Namely, the even-X electrode driver 510 is comprised of a driver (first reset driver) for generating a reset pulse to be applied to the even-numbered row electrode X and odd-numbered row electrode Y and a driver (first sustain driver) for generating a sustain pulse to be applied to the even-numbered row electrode X and the odd-numbered row electrode Y. The odd-X electrode driver 530 is a driver (first scanning driver) for applying a scanning pulse sequentially to the odd-numbered row electrode Y. The odd-X electrode driver 520 is comprised of a driver (second reset driver) for generating a reset pulse to be applied to the odd-numbered row electrode X and the even-numbered row electrode Y and a driver (second sustain driver) for generating a sustain pulse to be applied to the odd-numbered row electrode X and even-numbered row electrode Y. The even-Y electrode driver 540 is a driver (second scanning driver) for applying a scanning pulse sequentially to the even-numbered row electrode Y.

According to the arrangement shown in FIG. 17, there is the reduced number of intersections electrically connecting between the drivers (510, 520, 530, 540) and the display electrode-formed region DPE similarly to the case shown in FIG. 4 as compared to the case employing an arrangement as shown in FIG. 3. Accordingly, this interconnect form reduces the floating capacitance existing between the lines, thus reducing the ineffective power consumption as caused by ineffective charge/discharge to/from the floating capacitance. Meanwhile, according to the driving as shown in FIG. 11, the same polarity of a reset pulse or sustain pulse is always applied to the odd-numbered row electrode Y and the even-numbered row electrode X at all times (except for a time of scanning pulse SP application). Accordingly, during application of a reset pulse or sustain pulse, nearly 0 volt is applied to between the adjacent ones of the connection terminals T_{Y1}, T_{Y3}, . . . , T_{Y(n-1)} and T_{XE} (or connection terminals T_{Y2}, T_{Y4}, . . . , T_{Y(n)} and T_{XO}) provided on the display electrode-formed region DPE. This suppresses against failures, such as migration or insufficient breakdown strength, at between the adjacent connection terminals.

This application is based on Japanese patent applications No. 2003-333080 and No. 2004-220222 which are hereby incorporated by reference.

1. A display device having a display panel having a front substrate and a back substrate that are oppositely arranged sandwiching a discharge space, a plurality of electrodes X and electrodes Y extending in a row direction of arrangement on said front substrate, and a plurality of address electrodes arranged crossing said electrodes Y and said electrodes X respectively, to form unit luminescent regions at intersections of pairs of said electrodes Y and X and said address electrodes, comprising:
a plurality of odd-Y electrode connection terminals formed at one end of said front substrate in the row direction, the plurality of odd-Y electrode connection terminals being connected to respective electrodes Y arranged at odd-number-th positions;
an odd-X electrode connection terminal formed at said one end of said front substrate in the row direction, said odd-X electrode connection terminal being connected to the electrodes X arranged at odd-number-th positions;
a plurality of even-Y electrode connection terminals formed at other end of said front substrate in the row direction, the plurality of even-Y electrode connection terminals being connected to respective electrodes Y arranged at even-number-th positions;
an even-X electrode connection terminal formed at said other end of said front substrate in the row direction, said even-X electrode connection terminal being connected to the electrodes X arranged at even-number-th positions;
an odd-Y electrode driver for applying a scanning pulse sequentially to each of the electrodes Y arranged at odd-number-th positions through the respective odd-Y electrode connection terminals;
an even-Y electrode driver for applying a scanning pulse sequentially to each of the electrodes Y arranged at even-number-th positions through the respective even-Y electrode connection terminals;
an odd-X electrode driver for applying a sustain pulse repeatedly to the electrodes X arranged at odd-number-th positions through said odd-X electrode connection terminal; and
an even-X electrode driver for applying a sustain pulse repeatedly to the electrodes X arranged at even-number-th positions through said even-X electrode connection terminal.

2. A display device according to claim 1, wherein said unit luminescent region comprises a first discharge cell and a second discharge cell provided with a light-absorbing layer on a side close to said front substrate.

3. A display device according to claim 1, further comprising an address driver for applying, simultaneously with said scan pulse, a pixel data pulse corresponding to image data based on an input video signal in an amount of one display line per time to said address electrodes, to selectively cause address discharge within said second discharge cell.

4. A display device according to claim 3, wherein a secondary electron emitting material layer is provided in said second discharge cell on a side close to said back substrate,
said address driver, said odd-Y electrode driver and said even-Y electrode driver applying said pixel data pulse and said scan pulse having such a polarity that said address electrode side is relatively rendered negative in polarity,
said odd-X electrode driver and said even-X electrode driver applying said sustain pulse negative in polarity.

5. A display device according to claim 3, wherein said address discharge to be caused within said second discharge cell is extended into said first discharge cell, to set said first discharge cell in any one of turn-on mode or turn-off mode.

6. A display device according to claim 2, wherein said first discharge cell includes a portion where said electrode Y and said electrode X are opposed through a first discharge gap within said discharge space,
said second discharge cell including a portion where said address electrode and said electrode Y are opposed through a second discharge gap within said discharge space.

7. A display device according to claim 2, wherein said electrode Y and said electrode X each have a main body portion extending in the row direction of a display screen and projection portion opposed through the first discharge gap and projecting in a column direction of the display screen from said main body portion in each unit luminescent region,
said first discharge cell including a portion that said projection portions oppose through said first discharge gap within said discharge space, said second discharge cell including a portion that said address electrode and said main body portion of said electrode Y oppose through said second discharge gap within said discharge space.

8. A display device according to claim 2, wherein said display panel has a partition comprising a first column partition demarcating, in the row direction of said display surface, said discharge space of said unit luminescent regions adjacent to each other and a row partition demarcating it in the column direction, and a second column partition demarcating between a discharge section of the first discharge cell and a discharge section of the second discharge cell within the unit luminescent region,
the discharge space of said second discharge cell of each of said unit luminescent regions being closed by said partition from the discharge space of an adjacent one of the unit luminescent regions, the discharge space of the said discharge cells of said unit luminescent regions adjacent in the row direction being mutually in communication and the discharge space of said first discharge cells within said unit luminescent region being in mutual communication.

9. A display device according to claim 2, wherein a fluorescent layer for luminescent under discharge is formed only within said first discharge cell.

10. A display device having a display panel having front and back substrates oppositely arranged sandwiching a discharge space, a plurality of electrodes X and electrodes Y arranged extending in a row direction on the front substrate, and a plurality of address electrodes arranged crossing the electrodes Y and the electrodes X, to form unit luminescent regions at intersections of pairs of the electrodes Y and X and the address electrodes, comprising:
a plurality of odd-Y electrode connection terminals formed at one end of said front substrate in the row direction, the plurality of odd-Y electrode connection terminals being connected to respective electrodes Y arranged at odd-number-th positions;
an even-X electrode connection terminal formed at said one end of said front substrate in the row direction, said even-X electrode connection terminal being connected to the electrodes X arranged at even-number-th positions;
a plurality of even-Y electrode connection terminals formed at other end of said front substrate in the row direction, the plurality of even-Y electrode connection terminals being connected to respective electrodes Y arranged at even-number-th positions;
an odd-X electrode connection terminal formed at said other end of said front substrate in the row direction, said odd-X electrode connection terminal being connected to the electrodes X arranged at odd-number-th positions;
a first reset driver for generating a first reset pulse and applying it to said even-X electrode connection terminal and each of the odd-Y electrode connection terminals;
a first sustain driver for generating a first sustain pulse and applying it to said even-X electrode connection terminal and each of the odd-Y electrode connection terminals;
a first scanning driver for generating a scanning pulse and applying it sequentially to each of odd-Y electrode connection terminals;
a second reset driver for generating a second reset pulse and applying it to said odd-X electrode connection terminal and each of the even-Y electrode connection terminals;
a second sustain driver for generating a second sustain pulse and applying it to said odd-X electrode connection terminal and each of the even-Y electrode connection terminals; and
a second scanning driver for generating a scanning pulse and applying it sequentially to each of the even-Y electrode connection terminals.

11. A display device according to claim 10, wherein the plurality of row electrodes X and Y are arranged in a form of X, Y, X, Y or Y, X, Y, X on said display panel.
